(19) United States
(12) Patent Application Publication
(10) Pub. No.: US 2014/0166923 A1
(43) Pub. Date: Jun. 19, 2014

(54) COMPOSITIONS CONTAINING DIFLUOROMETHANE AND FLUORINE SUBSTITUTED OLEFINS

(71) Applicant: HONEYWELL INTERNATIONAL INC., MORRISTOWN, NJ (US)

(72) Inventors: Samuel F. Yana Motta, East Amherst, NY (US); Mark W. Spatz, East Amherst, NY (US); Ryan Hulse, Getzville, NY (US)

(21) Appl. No.: 14/188,346

(22) Filed: Feb. 24, 2014

Related U.S. Application Data
(63) Continuation-in-part of application No. 12/511,954, filed on Jul. 29, 2009.
Application No. 12/511,954 is a continuation-in-part of application No. PCT/US08/69139, filed on Jul. 3, 2008.
Application No. PCT/US08/69139 is a continuation of application No. 11/773,959, filed on Jul. 6, 2007, now abandoned.
Application No. 11/773,959 is a continuation-in-part of application No. 11/475,605, filed on Jun. 26, 2006.
Application No. 11/475,605 is a continuation-in-part of application No. 10/694,272, filed on Oct. 27, 2003, now Pat. No. 7,230,146.
Application No. 10/694,272 is a continuation-in-part of application No. 10/695,212, filed on Oct. 27, 2003, now abandoned.
Application No. 11/475,605 is a continuation-in-part of application No. 10/694,273, filed on Oct. 27, 2003, now Pat. No. 7,534,366.
Application No. 10/694,273 is a continuation-in-part of application No. 11/385,259, filed on Mar. 20, 2006.
Application No. 11/385,259 is a continuation of application No. 10/695,212, filed on Oct. 27, 2003, now abandoned.
(60) Provisional application No. 61/769,179, filed on Feb. 25, 2013.
(60) Provisional application No. 61/099,382, filed on Sep. 23, 2008.
(60) Provisional application No. 61/084,997, filed on Jul. 30, 2008.
(60) Provisional application No. 60/693,853, filed on Jun. 24, 2005.
(60) Provisional application No. 60/421,263, filed on Oct. 25, 2002.
(60) Provisional application No. 60/421,435, filed on Oct. 25, 2002.

(51) Int. Cl. C09K 5/04

(52) U.S. Cl. CPC C09K 5/045
USPC 252/68; 252/67

(57) ABSTRACT

Compositions comprising HFO-1234ze(E) and HFC-32 are disclosed. Such compositions are useful particularly for in stationary refrigeration and air conditioning equipment.

### RELATED APPLICATIONS

The present application claims priority to U.S. Provisional Application Ser. No. 61/769,179, filed Feb. 25, 2013, the contents of which are incorporated herein by reference in its entirety.

The present application is related to (as a continuation in part) and claims the priority benefit of U.S. application Ser. No. 12/511,954, filed Jul. 29, 2009, which is a continuation-in-part of International Application No. PCT/US2008/069139, filed Jul. 3, 2008, which in turn claims the priority benefit of Ser. No. 11/773,959, filed Jul. 6, 2007. Each of the applications identified in this paragraph are incorporated herein by reference as if fully set forth below.

The present application also is related to (as a continuation in part) and claims the priority benefit of each of the following U.S. applications: Ser. No. 11/475,605 filed Jun. 26, 2006, currently pending, which in turn claims the priority benefit of provisional application 60/693,853, filed Jun. 24, 2005, and which is also related as a continuation in part to each of the following regular US applications: Ser. Nos. 10/694,273; 10/695,212; 10/694,272, each of which was filed on Oct. 27, 2003. The present application is also related to and claims the priority benefit of each of the following U.S. applications: Ser. No. 11/385,259, filed Mar. 20, 2006, which in turn claims the benefit of Ser. No. 10/695,212, which was filed Oct. 23, 2003, now abandoned. The present application also is related to and claims the priority benefit of each of the following U.S. provisional applications: 61/099,382, filed Sep. 23, 2008 and 61/084,997, filed Jul. 30, 2008. Each of the applications identified in this paragraph are incorporated herein by reference as if fully set forth below.

### FIELD OF THE INVENTION

This invention relates to heat transfer compositions, methods and systems and more particularly to composition and methods well adapted for use in stationary refrigeration and air conditioning equipment.

### BACKGROUND

Fluorocarbon based fluids have found widespread use in many commercial and industrial applications, including as the working fluid in systems such as air conditioning, heat pump and refrigeration systems, among other uses such as aerosol propellants, as blowing agents, and as gaseous dielectrics.

Heat transfer fluids, to be commercially viable, must satisfy certain very specific and in certain cases very stringent combinations of physical, chemical and economic properties. Moreover, there are many different types of heat transfer systems and heat transfer equipment, and in many cases it is important that the heat transfer fluid used in such systems possess a particular combination of properties that match the needs of the individual system. For example, systems based on the vapor compression cycle usually involve the phase change of the refrigerant from the liquid to the vapor phase through heat absorption at a relatively low pressure and compressing the vapor to a relatively elevated pressure, condensing the vapor to the liquid phase through heat removal at this relatively elevated pressure and temperature, and then reducing the pressure to start the cycle over again.

For example, certain fluorocarbons have been a preferred component in many heat exchange fluids, such as refrigerants, for many years in many applications. Fluoroalkanes, such as chlorofluoromethanes and chlorofluoroethanes, have gained widespread use as refrigerants in applications including air conditioning and heat pump applications owing to their unique combination of chemical and physical properties, such as heat capacity, flammability, stability under the conditions of operation, and miscibility with the lubricant (if any) used in the system. Moreover, many of the refrigerants commonly utilized in vapor compression systems are either single components fluids, or zeotropic, azeotropic mixtures.

Concern has increased in recent years about potential damage to the earth's atmosphere and climate, and certain chlorine-based compounds have been identified as particularly problematic in this regard. The use of chlorine-containing compositions (such as chlorofluorocarbons (CFCs), hydrochlorofluorocarbons (HCFCs) and the like) as refrigerants in air-conditioning and refrigeration systems has become disfavored because of the ozone-depleting properties associated with many of such compounds. There has thus been an increasing need for new fluorocarbon and hydrofluorocarbon compounds that offer alternatives for refrigeration and heat pump applications. For example, it has become desirable to retrofit chlorine-containing refrigeration systems by replacing chlorine-containing refrigerants with non-chlorine-containing refrigerant compounds that will not deplete the ozone layer, such as hydrofiuorocarbons (HFCs).

Another concern surrounding many existing refrigerants is the tendency of many such products to cause global warming. This characteristic is commonly measured as global warming potential (GWP). The GWP of a compound is a measure of the potential contribution to the green house effect of the chemical against a known reference molecule, namely, CO₂ which has a GWP=1. For example, the known refrigerant R-410 has a Global Warming Potential of 2088. While this refrigerant has proven effective in many respects, it has become increasingly less preferred since it is frequently undesirable to use materials having GWPs greater than about 1000. A need exists, therefore, for more environmentally friendly substitutes for high GWP refrigerants in general and R-410A in particular refrigerants having undesirable GWPs. For example, it has become desirable to retrofit certain systems, including chlorine-containing and certain HFC-containing refrigeration systems by replacing the existing refrigerants with refrigerant compositions that will not deplete the ozone layer, will not cause unwanted levels of global worming, and at the same time will satisfy all of the other stringent requirements of such systems for the materials used as the heat transfer material.

With respect to performance properties, the present applicants have come to appreciate that any potential substitute refrigerant must also possess those properties present in many of the most widely used fluids, such as excellent heat transfer properties, chemical stability, low- or no-toxicity, low or non-flammability and lubricant compatibility, among others.

With regard to efficiency in use, it is important to note that a loss in refrigerant thermodynamic performance or energy efficiency may have secondary environmental impacts through increased fossil fuel usage arising from an increased demand for electrical energy.

Furthermore, it is generally considered desirable for refrigerant substitutes to be effective without major engineering changes to conventional vapor compression technology currently used with existing refrigerants, such as CFC-containing refrigerants.

Applicants have thus come to appreciate a need for compositions, and particularly heat transfer compositions, that are potentially useful in numerous applications, including vapor compression heating and cooling systems and methods, while avoiding one or more of the disadvantages noted above.

Applicants have also come to appreciate that lubricant compatibility is of particular importance in many of applications. More particularly, it is highly desirably for refrigeration fluids to be compatible with the lubricant utilized in the compressor unit, used in most refrigeration systems. Unfortunately, many non-chlorine-containing refrigeration fluids, including HFC's, are relatively insoluble and/or immiscible in the types of lubricants used traditionally with CFC's and HFC's, including, for example, mineral oils, alkylbenzenes or poly(alpha-olefins). In order for a refrigeration fluid-lubricant combination to work at a desirable level of efficiently within a compression refrigeration, air-conditioning and/or heat pump system, the lubricant should be sufficiently soluble in the refrigeration liquid over a wide range of operating temperatures. Such solubility lowers the viscosity of the lubricant and allows it to flow more easily throughout the system. In the absence of such solubility, lubricants tend to become lodged in the coils of the evaporator of the refrigeration, air-conditioning or heat pump system, as well as other parts of the system, and thus reduce the system performance.

Flammability is another important property for many applications. That is, it is considered either important or essential in many applications, including particularly in heat transfer applications, to use compositions which are non-flammable or of relatively low flammability. As used herein, the term “nonflammable” refers to compounds or compositions which are determined to be nonflammable as determined in accordance with ASTM standard E-681, dated 2002, which is incorporated herein by reference. Unfortunately, many HFC's which might otherwise be desirable for used in refrigerant compositions are not flammable. For example, the fluoroalkane difluoroethane (HFC-152a) and the fluoroalkene 1,1,1-trifluorpropene (HFO-1243zf) are each flammable and therefore not viable for use alone in many applications.

Higher fluoroalkenes, that is fluorine-substituted alkenes having at least five carbon atoms, have been suggested for use as refrigerants. U.S. Pat. No. 4,788,352—Smutny—is directed to production of fluorinated C₅ to C₈ compounds having at least some degree of unsaturation. The Smutny patent identifies such higher olefins as being known to have utility as refrigerants, pesticides, dielectric fluids, heat transfer fluids, solvents, and intermediates in various chemical reactions. (See column 1, lines 11-22).

While the fluorinated olefins described in Smutny may have some level of effectiveness in heat transfer applications, it is believed that such compounds may also have certain disadvantages. For example, some of these compounds may tend to attack substrates, particularly general-purpose plastics such as acrylic resins and ABS resins. Furthermore, the higher olefinic compounds described in Smutny may also be undesirable in certain applications because of the potential level of toxicity of such compounds which may arise as a result of pesticide activity noted in Smutny. Also, such compounds may have a boiling point which is too high to make them useful as a refrigerant in certain applications.

### SUMMARY

According to one aspect of the present invention, applicants have found that one or more of the above-noted needs, and possibly other needs, can be satisfied by refrigerant compositions comprising, and in certain preferred embodiments consisting essentially of, from about 61% by weight to about 69% by weight of difluoromethane (R-32) and from about 31% by weight to about 39% by weight of tetrafluoropropene, more preferably 1,1,1,3-tetrafluoropropene (HFO-1234ze), and even more preferably trans 1,1,1,3-tetrafluoropropene (transHFO-1234ze or HFO-1234ze(E)).

The term “HFO-1234” is used herein to refer to all tetrafluoropropenes. Among the tetrafluoropropenes are included 1,1,1,2-tetrafluoropropene (HFO-1234yf) and both cis- and trans-1,1,1,3-tetrafluoropropene (HFO-1234ze). The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

The present invention provides also methods and systems which utilize the refrigerant compositions of the present invention, in refrigeration systems, including particularly and preferably in systems and methods which have heretofore used the refrigerant R-410A, including particularly stationary refrigeration systems, including residential and commercial air conditioning equipment. Other aspects of the invention include methods and systems for replacing R-410A in an existing heat transfer system with a refrigerant of the present invention.

### DETAILED DESCRIPTION OF PREFERRED EMBODIMENTS THE COMPOSITIONS

As provided herein, the refrigerant compositions of the present invention include difluoromethane (R-32) and tetrafluoropropene. The relative amount of HFC-32 and the tetrafluoropropene in the refrigerant composition of the present invention is critically important to the provision of the properties and features provided by the preferred aspects of the present invention. More specifically, and as explained in detail in the examples here of, refrigerant compositions comprising the components in the amounts as required by the present claims produce a highly desirable but unexpected combination of properties, including particularly heat transfer capacity and heat transfer efficiency that closely match and/or provide improvement over R-410, while at the same time providing dramatic improvement in the environmental properties of the refrigerant. As can be readily appreciated, this discovery is of potentially enormous advantage and benefit for the formulation of many important refrigerant methods and systems.

It is generally preferred that the tetrafluoropropene of the present invention comprises, and in many preferred embodiment consists essentially of (trans)HFO-1234ze. As is known, HFO-1234ze(E) has a normal boiling point of −19° C. In comparison, (cis)HFO-1234ze has a normal boiling point of +9° C. Thus, it is possible that in certain applications relatively small amounts, for example, up to 5% by weight of the composition, of the cis- and trans-isomers, and perhaps other tetrafluoropropenes such as HFO-1234yf, will be acceptable and/or preferred in many embodiments. Nevertheless, in certain highly preferred embodiments, the tetrafluoride are, and according to the present invention consists essentially of, and even more preferably in certain embodiments consists of, HFO-1234ze(E).

Another advantage of certain embodiments of the present invention is the provision of compositions having exceptional flammability properties while retaining other important properties in the desirable range. Applicants have come to appreciate that both R-32 and HFO-1234yf have measurable flame limits at room temperature. However, applicants note that the flame hazard of the preferred compositions of the present invention based upon HFO-1234ze compare favorably to other HFCs such as R-152a and HCs such as R-290. One way of ranking the flammability of these materials is to measure the flame speed of each compound. The maximum flame speed of R-32, R-152a and R-290 have been reported (Jabbour) to be 6.7, 23.0 and 38.5 cm/s, respectively. The refrigerant compositions of the present invention have a flame speed of less than 6.7 cm/s.

In certain preferred forms, the refrigerant compositions of the present invention, also have a Global Warming Potential (GWP) of not greater than about 1600, more preferably not greater than about 1000, and even more preferably not greater than about 500. In certain preferred embodiments, the GWP is not greater than about 150, more preferably not greater than about 100 and even more preferably not greater than about 75. As used herein. “GWP” is measured relative to that of carbon dioxide and over a 100 year time horizon, as defined in “The Scientific Assessment of Ozone Depletion, 2002, a report of the World Meteorological Association's Global Ozone Research and Monitoring Project,” which is incorporated herein by reference.

In certain preferred forms, the present compositions also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

It is contemplated that amounts of additional compounds or components, including stabilizers, metal passivators, corrosion inhibitors, flammability suppressants, and other compounds and/or components that modulate a particular property of the refrigerant compositions may be included in the present compositions, provided the HFC-32 and tetrafluoropropene are present in accordance with the ranges specified herein, the presence of all such additional compounds and components is within the broad scope of the invention.

Heat Transfer Compositions

The refrigerant compositions of the present invention are generally adaptable for use in heat transfer applications, that is, as a heating and/or cooling medium, including as evaporative cooling agents.

The compositions of the present invention may include other components for the purpose of enhancing or providing certain functionality to the composition, or in some cases to reduce the cost of the composition. For example, heat transfer compositions of the present invention include the present refrigerant compositions and a lubricant, with the lubricant in preferred embodiments being present in the heat transfer composition in amounts of from about 30 to about 50 percent by weight of the heat transfer composition. Furthermore, the present compositions may also include a co-refrigerant, or compatibilzer, such as propane, for the purpose of aiding compatibility and/or solubility of the lubricant. Such compatibilizers, including propane, butanes and pentanes, are preferably present in amounts of from about 0.5 to about 5 percent by weight of the composition. However, such compatibilizers may be replaced with one or more of the additional components (e.g. fluorinated alkanes) discussed herein.

Combinations of surfactants and solubilizing agents may also be added to the present compositions to aid oil solubility, as disclosed by U.S. Pat. No. 6,516,837, the disclosure of which is incorporated by reference. Commonly used refrigeration lubricants such as Polyol Esters (POEs) and Poly Alkylene Glycols (PAGs), PAG oils, silicone oil, mineral oil, alkyl benzenes (ABs) and poly(alpha-olefin) (PAO) that are used in refrigeration machinery with hydrofluorocarbon (HFC) refrigerants may be used with the refrigerant compositions of the present invention. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available alkyl benzene lubricants include Zerol 150 (registered trademark). Commercially available esters include neopentyl glycol dipelargonate, which is available as Emery 2917 (registered trademark) and Hatcol 2370 (registered trademark). Other useful esters include phosphate esters, dibasic acid esters, and fluoroesters. In some cases, hydrocarbon based oils are have sufficient solubility with the refrigerant that is comprised of an iodocarbon, the combination of the iodocarbon and the hydrocarbon oil might more stable than other types of lubricant. Such combination may therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used.

The present methods, systems and compositions are thus adaptable for use in connection with a wide variety of heat transfer systems in general and refrigeration systems in particular, such as air-conditioning (including both stationary and mobile air conditioning systems), refrigeration, heat-pump systems, and the like. In certain preferred embodiments, the compositions of the present invention are used in stationary refrigeration systems, such as stationary air conditioning units and stationary refrigeration originally designed for use of, R-410A. The preferred compositions of the present invention tend to exhibit many of the desirable characteristics of these existing refrigerants, including a GWP that is as low, or lower than the existing refrigerant and a capacity that is as high or higher than such refrigerants and a capacity that is substantially similar to or substantially matches, and preferably is as high as or higher than such refrigerants. In particular, applicants have recognized that certain preferred embodiments of the present compositions tend to exhibit relatively low global warming potentials (“GWPs”), preferably less than about 1000, more preferably less than about 500, and even more preferably less than about 150, commercial refrigeration systems and the like.

Many existing refrigeration systems are currently adapted for use in connection with existing refrigerants, and the compositions of the present invention are believed to be adaptable for use in many of such systems, either with or without system modification

In general, the preferred heat transfer compositions of the present invention are not azeotropic over much, and potentially over the entire, range of temperatures and pressures of use. That is, the mixtures of the components produce a liquid with a non-constant boiling temperature, therefore producing what is know as a “temperature glide” in the evaporator and condenser. The “temperature glide” is the change in temperature that occurs as a zeotropic material condenses or evaporates. This glide is preferably considered in connection with the method and composition aspects of the present invention in order to provide a composition which most effectively matches the refrigerant composition being replaced. In certain preferred embodiments, the present refrigerant compositions produce a temperature glide of not greater than about 8° C. under conditions of actual or contemplated use.

The present compositions are also believed to be suitable as replacements for many compositions that are currently used in other applications, such as aerosols, blowing agents and the like, as explained elsewhere herein.

Particularly preferred embodiments of the compositions of the present invention are described below.

HFC-32/HFO-1234ze Based Compositions

The preferred refrigerant compositions of the present invention comprise HFC-32 in amount of from greater than about 61 wt. % to less than about 70%, more preferably from about 62 wt. % to less than about 69%, and even more preferably from about 65 wt. % to less than about 69%, with an amount of about 68% by weight being preferred in certain embodiments.

HFO-1234ze, preferably transHFO-1234ze, is provided in the composition from an amount preferably from about 30 wt % to about 39 wt % percent, more preferably from about 31 wt % to about 38 wt %, and even more preferably from about 31 wt % to about 35 wt % by weight, with an amount of about 32 wt % in certain preferred embodiments. According to certain preferred embodiments of the present invention the amount of HFO-1234ze, particularly and preferably in connection with embodiments in which the composition is intended or used as a replacement or alternative to R-410A or R-404A. Applicants have found that compositions within this range provide refrigerant fluids that have a global warming potential (GWP) that is much less than many standard refrigerants, including R-410A, while at the same time exhibiting performance parameters that are commercially comparable to or improved with respect to such previously used refrigerants, including particularly R404A, R410A and R-22. Applicants have surprisingly and/or advantageously found that compositions of the present invention comprising the preferred concentrations of components described herein are capable of providing an excellent match in the parameter of discharge temperature for refrigerants such as R-410A while still achieving acceptable or improved performance parameters in connection with capacity and efficiency.

Methods and Systems

The compositions of the present invention are useful in connection with numerous methods and systems, including as heat transfer fluids in methods and systems for transferring heat, such as refrigerants used in refrigeration, air conditioning and heat pump systems.

Heat Transfer Methods and Systems

The preferred heat transfer methods generally comprise providing a composition of the present invention and causing heat to be transferred to or from the composition, either by sensible heat transfer, phase change heat transfer, or a combination of these. For example, in certain preferred embodiments the present methods provide refrigeration systems comprising a refrigerant of the present invention and methods of producing heating or cooling by condensing and/or evaporating a composition of the present invention. In certain preferred embodiments, the methods for cooling, including cooling of other fluid either directly or indirectly or a body directly or indirectly, comprise condensing a refrigerant composition comprising a composition of the present invention and thereafter evaporating said refrigerant composition in the vicinity of the article to be cooled. As used herein, the term “body” is intended to refer not only to inanimate objects but also to living tissue, including animal tissue in general and human tissue in particular. For example, certain aspects of the present invention involve application of the present composition to human tissue for one or more therapeutic purposes, such as a pain killing technique, as a preparatory anesthetic, or as part of a therapy involving reducing the temperature of the body being treated. In certain embodiments, the application to the body comprises providing the present compositions in liquid form under pressure, preferably in a pressurized container having a one-way discharge valve and/or nozzle, and releasing the liquid from the pressurized container by spraying or otherwise applying the composition to the body. As the liquid evaporates from the surface being sprayed, the surface cools.

Certain preferred methods for heating a fluid or body comprise condensing a refrigerant composition comprising a composition of the present invention in the vicinity of the fluid or body to be heated and thereafter evaporating said refrigerant composition. In light of the disclosure herein, those of skill in the art will be readily able to heat and cool articles according to the present inventions without undue experimentation.

Applicants have found that in the systems and methods of the present invention many of the important refrigeration system performance parameters are relatively dose to the parameters of the existing refrigerant group mentioned above. Those skilled in the art will appreciate the substantial advantage of a low GWP and/or a low ozone depleting refrigerant that can be used as replacement for the refrigerants with relatively minimal modifications to the system. It is contemplated that in certain embodiments the present invention provides retrofitting methods which comprise replacing the heat transfer fluid (such as a refrigerant) in an existing system with a composition of the present invention, without substantial modification of the system. In certain preferred embodiments the replacement step is a drop-in replacement in the sense that no substantial redesign of the system is required and no major item of equipment needs to be replaced in order to accommodate the composition of the present invention as the heat transfer fluid. In certain preferred embodiments, the methods comprise a drop-in replacement in which the capacity of the system is at least about 70%, preferably at least about 85%, and even more preferably at least about 95% of the system capacity prior to replacement. In certain preferred embodiments, the methods comprise a drop-in replacement in which the efficiency of the system is at least about 99%, preferably at least about 100% of the system efficiency prior to replacement. In certain preferred embodiments, the methods comprise a drop-in replacement in which the suction pressure and/or the discharge pressure of the system, and even more preferably both, is/are at least about 70%, more preferably at least about 90% and even more preferably at least about 95% of the suction pressure and/or the discharge pressure prior to replacement, and preferably not greater than about 130%, even more preferably less than about 115, and even more preferably less than about 110%. In certain preferred embodiments, the methods comprise a drop-in replacement in which the mass flow of the system is at least about 80%, and even more preferably at least 90% of the mass flow prior to replacement, and preferably not greater than about 130%, even more preferably less than about 115, and even more preferably less than about 110%.

In certain embodiments the present invention provides cooling by absorbing heat from a fluid or body, preferably by evaporating the present refrigerant composition in the vicinity of the body or fluid to be cooled to produce vapor comprising the present composition. Preferably the methods include the further step of compressing the refrigerant vapor, usually with a compressor or similar equipment to produce vapor of the present composition at a relatively elevated pressure. Generally, the step of compressing the vapor results in the addition of heat to the vapor, thus causing an increase in the temperature of the relatively high pressure vapor. Preferably in such embodiments the present methods include removing from this relatively high temperature, high pressure vapor at least a portion of the heat added by the evaporation and compression steps. The heat removal step preferably includes condensing the high temperature, high pressure vapor while the vapor is in a relatively high pressure condition to produce a relatively high pressure liquid comprising a composition of the present invention. This relatively high pressure liquid preferably then undergoes a nominally isoenthalpic reduction in pressure to produce a relatively low temperature, low pressure liquid. In such embodiments, it is this reduced temperature refrigerant liquid which is then vaporized by heat transferred from the body or fluid to be cooled.

In another process embodiment of the invention, the compositions of the invention may be used in a method for producing heating which comprises condensing a refrigerant comprising the compositions in the vicinity of a liquid or body to be heated. Such methods, as mentioned hereinbefore, frequently are reverse cycles to the refrigeration cycle described above.

### EXAMPLES

The following examples are provided for the purpose of illustrating the present invention.

A representative air-to-air reversible heat pump designed for R410A was tested. This ducted unit was tested in Honeywell's Buffalo, N.Y. application laboratory. The ducted unit is a 3-ton (10.5 kW cooling capacity) 13 SEER (3.8 cooling seasonal performance factor, SPF) with a heating capacity of 10.1 kW and an HSPF of 8.5 (rated heating SPF of ˜2.5), equipped with a scroll compressor. This system has tube-and-fin heat exchangers, reversing valves and thermostatic expansion valves for each operating mode. Due to the different pressures and densities of the refrigerants tested, some of the tests required the use of Electronic Expansion Valves (EEV) to reproduce the same degrees of superheat observed with the original refrigerants.

Tests were performed using standard (AHRI, 2008) operating conditions. All tests were performed inside environmental chambers equipped with instrumentation to measure both air-side and refrigerant-side parameters. Refrigerant flow was measured using a coriolis flow meter while air flow and capacity was measured using an air-enthalpy tunnel designed according to industry standards (ASHRAE, 1992). All primary measurement sensors were calibrated to ±0.25° C. for temperatures and ±0.25 psi for pressure. Experimental uncertainties for capacity and efficiency were on average ±5%. Capacity values represent the air-side measurements, which were carefully calibrated using the reference fluid (R-410A).

Using this system, testing was conducted on various R-32 and 1234ze containing compositions, including: (1) 60 wt. % R-32 and 40% 1234ze; (2) 68 wt. % R-32 and 32% 1234ze; and (3) 73 wt. % R-32 and 27% 1234ze. Each of the above blends were tested in this heat pump in both cooling and heating modes along with the baseline refrigerant R-410A. System capacity and efficiency results are provided in Table A below.

TABLE A
R32 Between 60 & 73% - Drop-In

| | % R32 with | Characteristics | | | Cooling | | | Heating Rating | | Heating Low T | |
|---|---|---|---|---|---|---|---|---|---|---|---|
| | Balance HFO- | | | Glide | Cap. | Eff. | Td (° F.) | (AHRI H1) | | (AHRI H4) | |
| Ref. | 1234ze(E) | Composition | GWP | Ev (° F.) | (AHRI A) | (AHRI B) | (239° F.) | Cap. | Eff. | Cap | Eff. |
| R410A | — | R32/125 (50/50) | 2100 | 0.1 | 100% | 100% | 204 | 100% | 100% | 100% | 100% |
| HDR-60 | 73% | R32/ze (73/27) | 494 | 6.9 | 98% | 102% | 233 | 96% | 103% | 96% | 102% |
| HDR-89 | 68% | R32/ze (68/32) | 459 | 7.9 | 95% | 103% | 226 | 93% | 103% | 90% | 98% |
| HDR-96 | 60% | R32/ze (60/40) | 407 | 10.8 | 89% | 100% | 220 | 88% | 102% | 83% | 94% |

The test result reported in Table A illustrates that, for drop-in replacements, the capacity of the tested fluids increased as the amount of R-32 is increased. That is, the capacity of a fluid having 60 wt. % HFC-32 and 40 wt. % 1234ze was 89% in a cooling application, 88% with a Heat Rating conducted according to AHRI H1, and 83% with Heat Testing at low temperatures in accordance with AHRI H4. When the amount of R-32 is increased from 60 wt % to 68 wt. %, the capacity rose in all three tests—i.e. to 95% for a cooling application; 93% for the AHRI H1 Heat Rating and 90% for AHRIH4 Heat Testing at low temperatures. An even further increase was shown as the amount of R-32 was increased to 73 wt. %. Such data demonstrates that as the amount of R-32 increased above 60 wt. %, the capacity, relative to R-410A, improved to be within critical levels that make it effective as an R-410A replacement fluid—i.e. within about 10%, and preferably within about 5%. What was further surprising was that the efficiency of the fluids also improved as R-32 was added. As one of skill in the art, I can attest that it is generally known in the art that as the capacity of a fluid increases, its efficiency decreases. This is, largely, because an increase in capacity generally results in increased load to the heat exchangers of the system. Thus, the expectation based on the data above was that the increase in capacity observed as the amount of R-32 is increased would result in a deleterious change to the effective evaporative temperature and condensing temperature. This, ultimately, makes the system less efficient and was expected to result in a decrease in the comparative efficiency percentage. Table A, however, surprisingly and unexpectedly demonstrates that the efficiency actually improves in the system as the amount of R-32 is increased. More specifically, the efficiency of the 60 wt. % 32 fluid was found to be 100% in a cooling application, 102% with a Heat Rating conducted according to AHRI H1, and 94% with Heat Testing at low temperatures in accordance with AHRI H4. When the amount of R-32 is increased from 60 wt % to 68 wt. %, the efficiency increased to 103% for a cooling application; 103% for the AHRI H1 Heat Rating and 98% for AHRI H4 Heat Testing at low temperatures. It is also noteworthy that as the amount of R-32 increased from 68 wt. % to 73 wt. % the efficiency of the system in the cooling application and AHRI H1 Heat Rating appears to level off. That is, while an increase in efficiency is still observed with AHRI H4 Heat Testing at low temperatures, the efficiency in the cooling application and AHRI H1 heat rating remained relatively flat. Again, one of skill in the art would expect that the efficiency should have decreased as the capacity rose. Thus, the fact that they remained relatively the same in the actual test data was wholly unexpected. Moreover, the leveling off that is observed is surprisingly advantageous because it occurs within a capacity and efficiency range that make the compositions effective as a R-410A replacement fluid—i.e. within about 10%, and preferably within about 5%.

The developmental blend, L-41 was tested in this heat pump in both cooling and heating modes along with the baseline refrigerant R-410A.

Those skilled in the art will appreciate that the foregoing description and examples are intended to be illustrative of the invention but not necessarily limiting of the full and true broad scope of the invention, which will be represented by the appended claims as presented now or hereinafter.

What is claimed is:

1. A refrigerant composition comprising:
(a) from about 61 wt % to about 69 wt % difluoromethane (R-32); and
(b) from about 31 to about 39 wt % of HFO-1234ze(E), each being measured relative to the total weight of HFO-1234ze(E) and HFC-32 in the composition.

2. The refrigerant composition of claim 1 wherein said composition comprises from about 65 wt. % to about 69% difluoromethane (R-32); and from about 31 wt % to about 35 wt % by weight of HFO-1234ze(E), each being measured relative to the total weight of HFO-1234ze(E) and HFC-32 in the composition.

3. The refrigerant composition of claim 1 wherein said composition comprises about 68 percent by weight of HFC-32 and about 32 percent by weight of HFO-1234ze(E), each being measured relative to the total weight of HFO-1234ze(E) and HFC-32 in the composition.

4. The refrigerant composition of claim 1, further comprising one or more additional compounds selected from the group consisting of stabilizers, metal passivators, corrosion inhibitors, lubricants and flammability suppressants.

5. The refrigerant composition of claim 1, further comprising at least one lubricant.

6. The refrigerant composition of claim 5, wherein the lubricant is selected from the group consisting of polyol ester oils (POEs), poly alkylene glycol oils (PAGs), silicone oils, mineral oils, alkyl benzenes (ABs) and poly(alpha-olefin) oils (PAO).

7. The refrigerant composition of claim 5, wherein the lubricant comprises a polyol ester oil (POE) or a poly alkylene glycol oil (PAG).

8. The refrigerant composition of claim 1, wherein the refrigerant composition has a Global Warming Potential (GWP) of not greater than about 500.

9. The refrigerant composition of claim 1, further comprising a butane.

10. A method of transferring heat to or from a fluid or body comprising causing a phase change in a composition of claim 1 and exchanging heat with said fluid or body during said phase change.

11. A refrigeration system comprising a composition in accordance with claim 1, said system being selected from the group consisting of automotive air conditioning systems, residential air conditioning systems, commercial air conditioning systems, residential refrigerator systems, residential freezer systems, commercial refrigerator systems, commercial freezer systems, chiller air conditioning systems, chiller refrigeration systems, heat pump systems, and combinations of two or more of these.

12. A method of replacing R-410A in a stationary air conditioning system comprising:
a. providing a system comprising R-410A as a refrigerant:
b. replacing R-410A with a composition of the composition of claim 1.

13. The method of claim 12 wherein said composition comprises from about 65 wt. % to about 69% difluoromethane (R-32); and from about 31 wt % to about 35 wt % by weight of HFO-1234ze(E), each being measured relative to the total weight of HFO-1234ze(E) and HFC-32 in the composition.

14. The method of claim 12 wherein said composition comprises about 68 percent by weight of HFC-32 and about 32 percent by weight of HFO-1234ze(E), each being measured relative to the total weight of HFO-1234ze(E) and HFC-32 in the composition.

15. The method of claim 12 wherein the composition further comprises one or more additional compounds selected from the group consisting of stabilizers, metal passivators, corrosion inhibitors, lubricants and flammability suppressants.

16. The method of claim 12 wherein the composition further comprises at least one lubricant.

17. The method of claim 16 wherein the lubricant is selected from the group consisting of polyol ester oils (POEs), poly alkylene glycol oils (PAGs), silicone oils, mineral oils, alkyl benzenes (ABs) and poly(alpha-olefin) oils (PAO).

18. The method of claim 16 wherein the lubricant comprises a polyol ester oil (POE) or a poly alkylene glycol oil (PAG).

19. The refrigerant composition of claim 1, wherein the refrigerant composition has a Global Warming Potential (GWP) of not greater than about 500.

20. A stationary air conditioning system comprising, as a refrigerant, a composition of claim 1.
